(19) United States
(12) Patent Application Publication
(10) Pub. No.: US 2012/0070273 A1
(43) Pub. Date: Mar. 22, 2012

(54) Energy producing wind turbine for laboratory exhaust systems

(76) Inventor: Robert A. DeLuca, JR., Medford, NY (US)

(21) Appl. No.: 13/200,056

(22) Filed: Sep. 15, 2011

Related U.S. Application Data
(60) Provisional application No. 61/403,397, filed on Sep. 15, 2010.

(51) Int. Cl. F03D 1/04

(52) U.S. Cl. 415/202

(57) ABSTRACT

Integration or application of an energy producing wind turbine to an exhaust system. The wind turbine is rotated by the exhaust system discharge air to produce energy. The wind turbine does not disperse potentially hazardous discharge air in an unsafe manner.

### RELATED APPLICATIONS

The above application claims priority to U.S. Provisional patent application Ser. No. 61/403,397, and the filing date of Sep. 15, 2010.

### FIELD OF THE INVENTION

The present invention relates to the integration or application of an energy producing wind turbine to an exhaust system. The wind turbine is rotated by the exhaust system discharge air to produce energy. The wind turbine can also be used to discharge potentially hazardous air.

### BACKGROUND OF THE INVENTION

Exhaust fans for potentially hazardous vapors produce a constant air plume flowing at a high velocity in the vertical direction off the roof of buildings. Recommended practice is for the air velocity to be at a minimum of 3000 feet per minute (˜34 miles per hour) as it exits the exhaust fan stack. The reason for this high velocity is to shoot the potentially contaminated air out away from the building, ensuring that the air is not re-entrained in the air intakes of the building air handing unit (AHU) and to aid in the dispersion and dilution of the contamination concentration in the exhausted air.

Wind turbines are used to harness the power of wind to spin a turbine to produce electrical energy. Exhaust fans could provide a constant and consistent air stream to spin the wind turbine.

If the exhaust is from a laboratory which produces potentially contaminated air, the turbine would need to be specially designed to not disperse the contaminated air on the downstream side of the turbine in an unsafe manner.

There is a need for a turbine that can derive energy from the exhaust air without affecting the plume or dilution.

U.S. Pat. No. 4,457,666 relates to an apparatus and method for deriving energy from a moving gas stream. One embodiment of the apparatus includes a frame mounted on a rotatable shaft. The frame has working blades and discharge blades mounted thereon, the arrangement of the discharge blades being sufficient to materially reduce any back pressure on the working blades. Flow control means are connected to the frame for normalizing the flow of the moving gas stream as it impinges on the working and discharge blades.

U.S. Pat. No. 6,935,841 relates to a fan assembly including a vertical axis wind turbine which is coupled to an air extraction or air supply fan. The wind turbine is located above and is coupled coaxially to the fan. The fan assembly also includes an auxiliary turbine to provide start up torque to initiate rotation of the wind turbine.

U.S. Pat. No. 7,365,447 relates to a horizontal axis wind turbine of a downwind type having a rotor disposed downwind of a tower. The rotor has a hub and a blade, and a nacelle supports the rotator rotatable through a main shaft connected to the hub. A cylindrical tower supports the rotation of the nacelle and an exhaust fan is disposed on the nacelle to exhaust air inside the nacelle.

U.S. Patent Publication 2009/0275279 relates to a solar engine which is vertically aligned along an interior portion of the building and is heated by solar radiation. The solar engine includes a warm air chamber at an upper portion of the solar engine and a hollow core positioned below the warm air chamber. Habitable spaces are positioned around the outside of the core toward an exterior of the building. Solar radiation on the warm air chamber creates a high temperature zone in the warm air chamber that induces a stack effect in which air rises through the core due to the lower temperatures in the core, and results in a negative pressure in the core. Air enters at a lower portion of the building and is pulled through the core by the solar engine. If the windows on the outside of the habitable spaces are open, the negative pressure in the core causes passive cross ventilation from the outside of the building through the habitable spaces and into the core, where the air rises to the warm air chamber and then out of the building. One or more wind turbines and generators positioned around the top of the core convert the moving air from the core into electrical energy to power the building.

U.S. Pat. No. 6,365,985 relates to an electricity generator powered by air conditioner exhaust having a wind turbine and a bracket to hold the wind turbine in a relatively fixed position to an air conditioner exhaust. The wind turbine has a propeller with two or more blades, a shaft and a generator. The bracket holds the wind turbine so the blades are turned by exhaust air through the air conditioner. The bracket can be a shroud. The invention includes a method for generating electricity from the air conditioning exhaust by holding a wind turbine in a relatively fixed proximity to an air conditioning exhaust port.

### SUMMARY OF THE INVENTION

The present invention relates to a wind turbine that is attached to or placed adjacent to an exhaust fan, ductwork or stack from a laboratory discharging potentially contaminated air. The wind turbine can be placed adjacent to a cluster of multiple exhaust fans, or exhaust stacks.

It is an object of the present invention for the exhaust fan, ductwork or stack to discharge potentially contaminated air.

It is an object of the present invention for the turbine to comprise rotors manufactured from fiberglass reinforced polyester, or coated metal for protection from potentially hazardous or corrosive exhaust air.

It is an object of the present invention for the turbine to comprise blades designed and oriented in such a way to assist or not interfere with the production of a high plume of the exhaust air to disperse the potential contaminants in the exhaust air.

The present invention relates to integrating and/or applying a wind turbine to an exhaust fan, ductwork or stack in such a manner that the wind turbine efficiently produces energy without dispersing the air in an unsafe manner.

The invention accordingly comprises an article of manufacture possessing the features, properties, and the relation of elements, which are exemplified herein, and the scope of the invention will be indicated in the attendant claims.

### BRIEF DESCRIPTION OF THE DRAWINGS

FIG. 1 illustrates an embodiment of the present invention illustrating a vertical axis wind turbine adjacent to or integrated with the exhaust fan stack.

FIG. 2 illustrates an embodiment of the present invention illustrating a horizontal axis wind turbine adjacent to or integrated with the exhaust fan stack.

FIG. 3 illustrates an embodiment of the present invention illustrating a wheel rotor wind turbine adjacent to or integrated with the exhaust fan ductwork.

FIG. 4 illustrates an embodiment of the present invention illustrating a ducted rotor wind turbine adjacent to or integrated with the exhaust fan stack.

FIG. 5 illustrates an embodiment of the present invention, illustrating a vertical axis wind turbine adjacent to or integrated with multiple exhaust fan stacks.

### DETAILED DESCRIPTION OF THE INVENTION

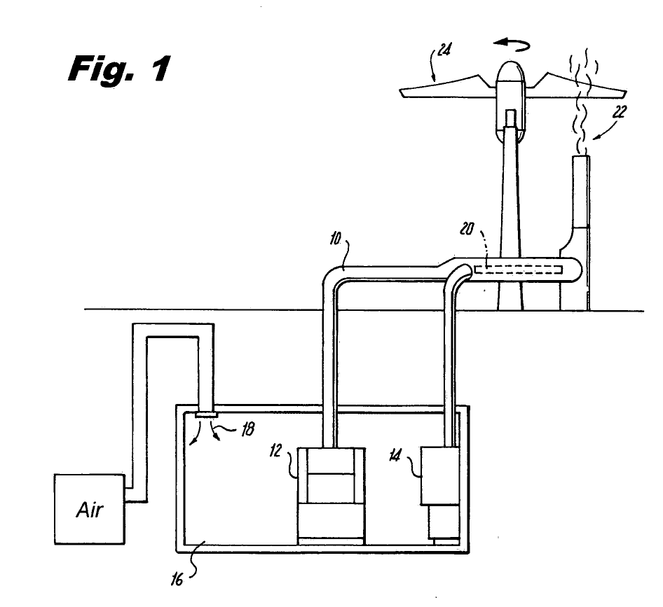

An embodiment for the wind turbine integrated with the exhaust fan is illustrated in the drawing FIG. 1 indicating a vertical axis wind turbine adjacent to or integrated with the exhaust fan, ductwork or stack.

FIG. 1 shows an exhaust system 10 which is hooked up to hoods 12 and 14 which are in a laboratory 16. An air supply 18 is provided to the laboratory 16. The exhaust system 10 has a fan 20 which provides exhaust air 22 to the wind turbine 24.

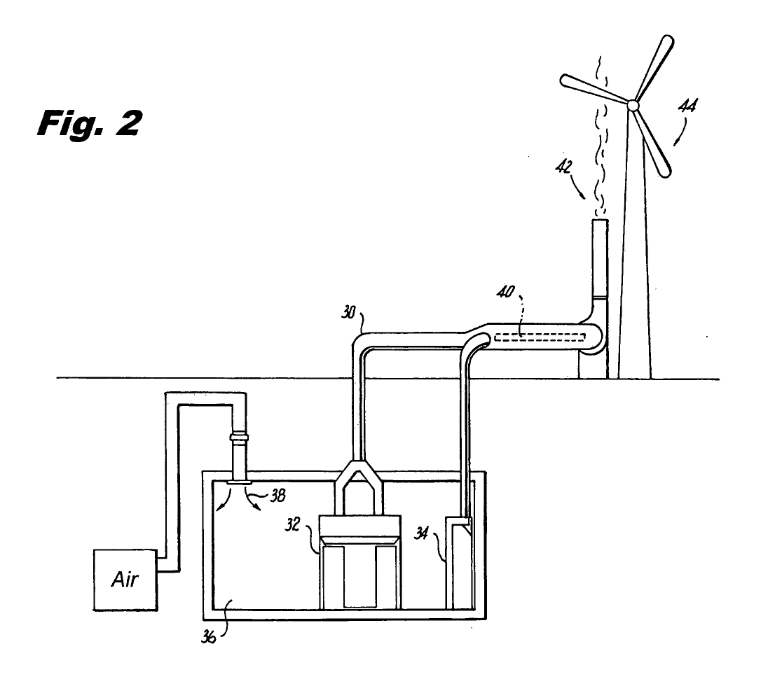

FIG. 2 illustrates an embodiment of the present invention wherein a horizontal axis wind turbine is adjacent to or integrated with the exhaust fan, ductwork or stack.

FIG. 2 shows an exhaust system 30 which is hooked up to hoods 32 and 34 which are in a laboratory 36. An air supply 38 is provided to the laboratory 36. The exhaust system 30 has a fan 40 which provides exhaust air 42 to the wind turbine 44.

In a further embodiment of the present invention, a horizontal axis wind turbine is adjacent to or integrated with the exhaust fan, ductwork or stack.

In a further embodiment, a darrieus wind turbine is adjacent to or integrated with the exhaust fan, ductwork or stack.

In a further embodiment, a giromill wind turbine is adjacent to or integrated with the exhaust fan, ductwork or stack.

In a further embodiment, a savonius wind turbine is adjacent to or integrated with the exhaust fan, ductwork or stack.

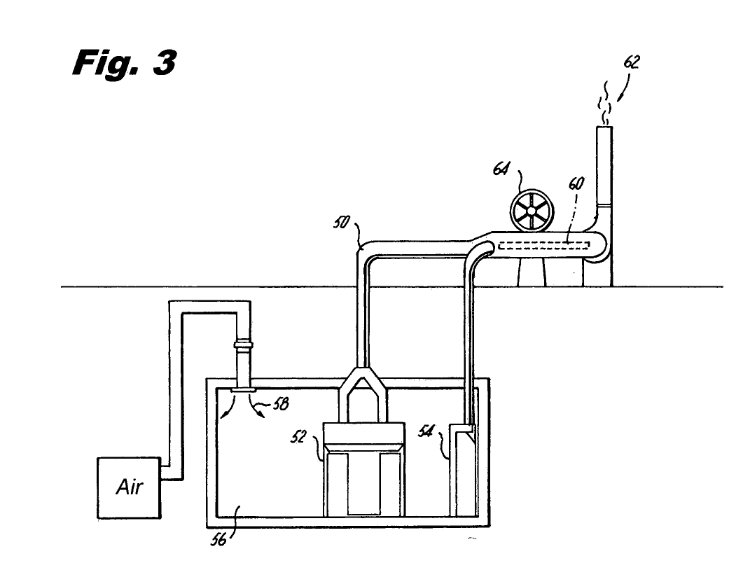

FIG. 3 illustrates an embodiment of the present invention, wherein a wheel rotor wind turbine is adjacent to or integrated with the exhaust fan, ductwork or stack.

FIG. 3 shows an exhaust system 50 which is hooked up to hoods 52 and 54 which are in a laboratory 56. An air supply 58 is provided to the laboratory 56. The exhaust system 50 has a fan 60 which provides exhaust air 62 to the wheel rotor wind turbine 64.

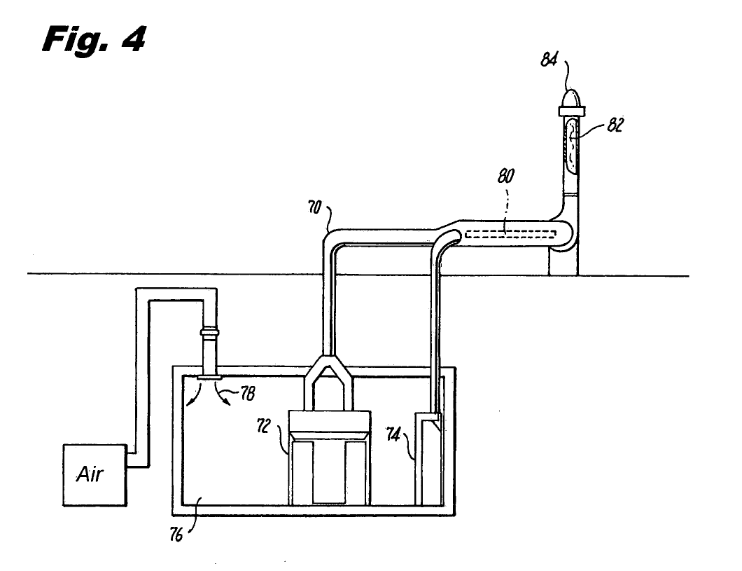

FIG. 4 illustrates an embodiment of the present invention wherein a ducted rotor wind turbine is adjacent to or integrated with the exhaust fan, ductwork or stack.

FIG. 4 shows an exhaust system 70 which is hooked up to hoods 72 and 74 which are in a laboratory 76. An air supply 78 is provided to the laboratory 76. The exhaust system 70 has a fan 80 which provides exhaust air 82 to the ducted rotor wind turbine 84.

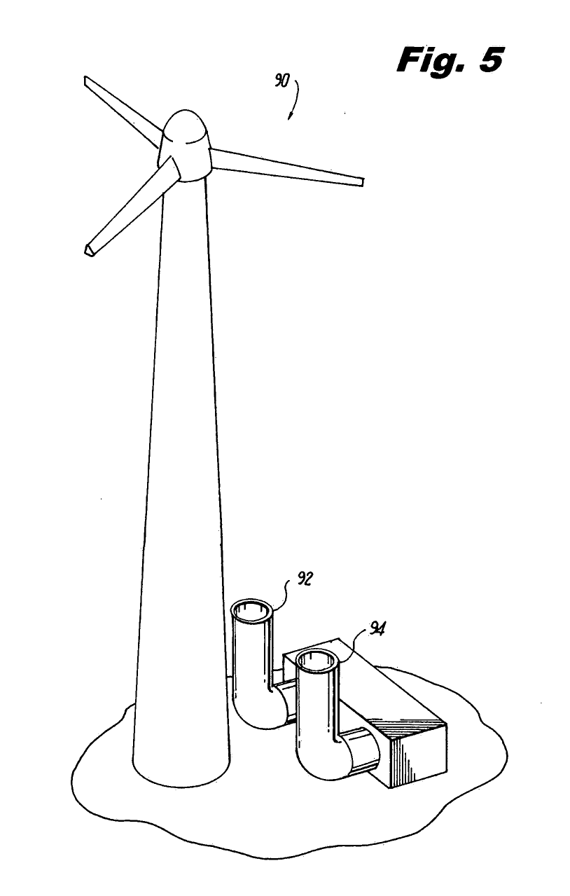

FIG. 5 illustrates the wind turbine 90 positioned adjacent to or integrated with a cluster of multiple exhaust fans or stacks 92, 94.

In a further embodiment, a co-axial multi-rotor horizontal axis wind turbine is adjacent to or integrated with the exhaust fan, ductwork or stack.

In a further embodiment, a counter rotating horizontal axis wind turbine adjacent to or integrated with the exhaust fan, ductwork or stack.

Having thus set forth a preferred constructions for this invention, it is to be remembered that this is but preferred embodiments.

It will thus be seen that the objects set forth above, among those made apparent from the preceding description, are efficiently attained and, since certain changes may be made in the above article without departing from the scope of the invention, it is intended that all matter contained in the above description or shown in the accompanying drawings shall be interpreted as illustrative and not in a limiting sense.

It is also to be understood that the claims asserted are intended to cover all of the generic and specific features of the invention herein described, and all statements of the scope of the invention, which as a matter of language, might be said to fall there between.

What is claimed is:

1. A wind turbine comprising:
rotors;
drive shafts;
gear box; and
a generator;
wherein said rotors are designed and or positioned to yield maximum energy production without negatively dispersing contaminated air on downstream side of said rotors;
said wind turbine being placed adjacent to an exhaust fan, ductwork or stack.

2. The wind turbine of claim 1 wherein said rotors do not disperse contaminated air on downstream side of said rotors.

3. The wind turbine of claim 1 wherein said turbine is integrated with or positioned adjacent to an exhaust fan discharging potentially contaminated air.

4. The wind turbine of claim 1 wherein said turbine is integrated with or positioned adjacent to duct work connected to an exhaust fan discharging potentially contaminated air.

5. The wind turbine of claim 1 wherein said turbine is integrated with or positioned adjacent to a stack connected to an exhaust fan discharging potentially contaminated air.

6. The wind turbine of claim 1 wherein said turbine is assembled adjacent to an existing exhaust fan.

7. The wind turbine of claim 1 wherein said turbine is assembled adjacent to or into an existing duct work system connected to an exhaust fan.

8. The wind turbine of claim 1 wherein said turbine is assembled adjacent to or into an existing stack or stacks connected to an exhaust fan or multiple exhaust fans.

9. The wind turbine of claim 1 wherein said turbine comprises rotors which are comprised of fiberglass reinforced polyester, or coated metal.

10. The wind turbine of claim 1 wherein said rotor comprises a material which is not corrosive to the exhaust air.
